(19) United States
(12) Patent Application Publication
(10) Pub. No.: US 2026/0185821 A1
(43) Pub. Date: Jul. 2, 2026

(54) SYSTEMS AND METHODS FOR OPTICAL DETERMINATION OF COATING QUALITY OF A GOLF BALL

(71) Applicant: ACUSHNET COMPANY, Fairhaven, MA (US)

(72) Inventor: Kevin J. Dietz, Warwick, RI (US)

(73) Assignee: ACUSHNET COMPANY, Fairhaven, MA (US)

(21) Appl. No.: 19/006,688

(22) Filed: Dec. 31, 2024

(51) Int. Cl. G01B 11/06; G01B 15/02

(52) U.S. Cl. CPC G01B 11/0625; G01B 11/0675; G01B 15/02

(57) ABSTRACT

The disclosed embodiments describe an apparatus, systems, and methods for optically determining coating properties on a golf ball. A golf ball may include a cover layer and a coating layer on the cover layer. A light emitter may be included for emitting an emitted light. A mount may be included for holding the golf ball. When the golf ball is held by the mount, the coating layer may be exposed to an incident light associated with the emitted light. A light sensor may be included for detecting an optical signal associated with a reflection of the incident light from the coating layer or the cover layer. A processor may be included for determining a coating thickness of the coating layer from the optical signal.

### BACKGROUND

The present disclosure relates generally to systems and methods for optically detecting and determining the coating quality of golf balls. More specifically, the present disclosure relates to using an optical method to detect qualitative or quantitative coating properties across the surface area of a golf ball.

A good coating quality on golf balls is valuable to ensure consistent performance, durability, and appearance. A high-quality coating provides smoothness and uniformity, helping the ball fly accurately and maintain its intended trajectory. It also protects the ball's surface from damage, wear, and environmental factors. Measuring the coating properties of golf balls is particularly challenging due to their curved surfaces and dimple patterns. Current methods often involve weighing the coated ball to estimate the amount of paint applied, which assumes a uniform coating and density. This mass-based approach, however, only provides an average measure and cannot detect variations in paint thickness across the surface. As a result, a ball with patchy or non-uniform coating could give the same measurement as a uniformly coated ball, potentially affecting performance and appearance standards. Furthermore, a mass-based approach to measure coating uniformity is destructive to the ball, making it impractical for in-line inspection within manufacturing processes.

The inability to monitor coating quality in real time has driven the need for advanced, non-destructive technologies capable of assessing both the amount and uniformity of the coating on golf balls during production. Such advancements would allow manufacturers to ensure quality and consistency at scale without compromising the integrity of the product. A high-quality coating preserves the integrity of a golf ball's surface, while uniform application ensures that aerodynamic performance is as designed.

### SUMMARY

The disclosed embodiments describe an apparatus, systems, and methods for optically determining coating properties on a golf ball. A golf ball may include a cover layer and a coating layer on the cover layer. A light emitter may be included for emitting an emitted light. A mount may be included for holding the golf ball. When the golf ball is held by the mount, the coating layer may be exposed to an incident light associated with the emitted light. A light sensor may be included for detecting an optical signal associated with a reflection of the incident light from the coating layer or the cover layer. A processor may be included for determining a coating thickness of the coating layer from the optical signal.

The disclosed embodiments describe an apparatus, systems, and methods for manufacturing a golf ball. A cover layer may be layered over a golf ball core. A cover layer of the covered golf ball core may be coated with a coating layer to produce the golf ball. Using a mount, the golf ball may be held. Using a light emitter, an emitted light may be emitted. The coating layer may be exposed to an incident light associated with the emitted light. Using a light sensor, an optical signal associated with a reflection of the incident light from the coating layer or the cover layer may be detected. Using a processor, a coating quality of the coating layer from the optical signal may be determined.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates components of a golf ball in a cross-sectional view, consistent with the disclosed embodiments.

FIG. 2A illustrates an example setup for detecting optical signals from a golf ball, consistent with the disclosed embodiments.

FIG. 2B illustrates optical detection of properties of a coating layer, consistent with the disclosed embodiments.

FIG. 3 illustrates an example of optical detection of properties of an absorbing coating layer, consistent with the disclosed embodiments.

FIG. 4 illustrates optical detection of multiple layers on a golf ball, consistent with the disclosed embodiments.

FIG. 5 illustrates optical detection of a dimple, consistent with the disclosed embodiments.

FIG. 6 is a flowchart illustrating an example process for determining a coating thickness of a golf ball, consistent with the disclosed embodiments.

FIG. 7 is a flowchart illustrating an example process for determining a coating thickness of a golf ball during manufacturing, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

The described herein provide a means of non-destructively determining coating properties of a ball, including coating weight or coating thickness. As used herein, a golf ball may be any ball used in the sport of golf. It should be understood that the embodiments disclosed herein may be modified to be used on any type of ball or object having similar materials or layering. By using optical techniques, coating thickness at various points along the surface of a golf ball may be determined without damage to the golf ball, including in areas where dimples may be located. These techniques would enhance the ability to perform in-field testing or real-time quality control during manufacturing efficiently and practically.

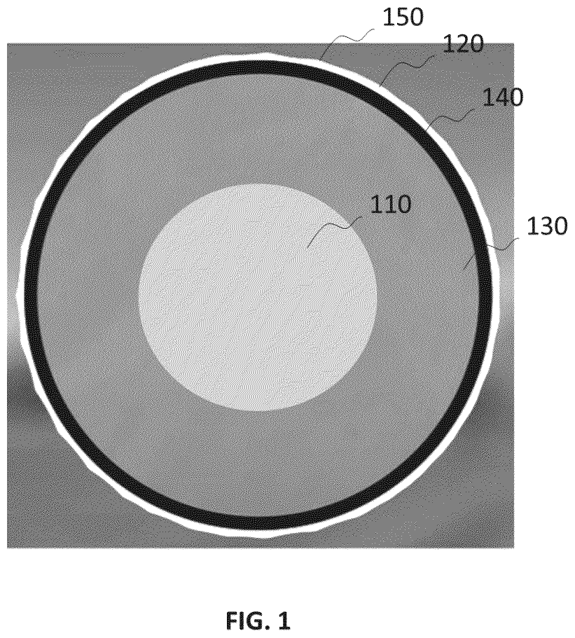

FIG. 1 illustrates components of a golf ball in a cross-sectional view. A golf ball generally includes core layer 110. Surrounding core layer 110 is cover layer 120. Cover layer 120 may be coated in coating layer 150. In some embodiments, a golf ball may include intermediate layer 130 or casing layer 140.

FIG. 1 depicts one particular arrangement of layers in a golf ball. In practice, any combination of layers may be used to form a golf ball. For example, a golf ball may include one or multiple intermediate layers. Intermediate layer 130 may be similar to core layer 110 or casing layer 140 in composition or function. For example, a golf ball may include two intermediate layers, with the first intermediate layer matches the elasticity of core layer 110, and the second intermediate layer matching the elasticity of casing layer 140. The embodiments disclosed herein may be implemented in a golf ball comprising any combination of core, intermediate, or casing layers.

Core layer 110, may include various polymers or elasticized rubbers. For example, core layer 110 may include synthetic rubbers infused with polymers, such as polybutadiene. Core layer 110 may also include additional materials like synthetic resins or plastics, cross-linking agents such as zinc diacrylate or zinc methacrylate, fillers such as zinc oxide, catalysts, and plasticizers.

Cover layer 120 may include urethane, a urethane elastomer, thermoplastic or thermoset urethane, ionomers (e.g., Surlyn®) or other thermoplastics. Cover layer 120 may include dimples on the exterior for aerodynamic benefits. Like core layer 110, cover layer 120 may have various materials that act as cross-linking agents, plasticizers, or fillers. Cover layer 120 may also include pigments for coloration, UV stabilizers to protect cover layer 120, or texturizing agents for grip.

Intermediate layer 130 of a golf ball may also be referred to as the mantle layer. Intermediate layer 130 may include materials like ionomer, urethane, or polybutadiene, or various materials also found in core layer 110. These materials are selected to balance durability, feel, and performance of the golf ball. Intermediate layer 130 may serve as a transition between core layer 110 and cover layer 120. It is designed to enhance the ball's spin control, distance, and responsiveness, depending on the design.

Casing layer 140 of a golf ball may be made of thermoplastic. A thermoplastic casing made from thermoplastics like ionomers and others. In some embodiments, casing layer 140 may not be used. For example, if cover layer 130 includes ionomers, casing layer 140 may be skipped in manufacturing. Casing layer 140 may be similar to intermediate layer 130.

Coating layer 150 may be applied to the exterior of cover layer 120. Coating layer 150 may be a paint, polyurethane or polymer finish. The type of finish used may depend on the materials of cover layer 120. Coating layer 150 materials may include polyurethane, acrylic, epoxy, fluoropolymers, UV stabilizers, pigments, etc. Coating layer 150 may be a durable, UV-resistant material finish to provide resistance to wear and tear during play. Coating layer 150 may also enhance the ball's visibility, especially when it is white or colored. Additionally, the paint layer may help smooth the surface to optimize the ball's flight characteristics. The coating layer may include any number of layers. For example, the coating layer may include a primer layer and a top coat layer. A uniform application of coating layer 150 may greatly benefit the aerodynamic performance of a golf ball. Determining the properties of coating layer 150 is useful to ascertain the uniformity, consistency, or quality of coating layer 150. Properties of coating layer 150 may include coating thickness, coat weight, durability, UV resistance, hydrophobicity, friction, aerodynamics, appearance, chemical resistance, or elasticity. Coat weight may be the mass of coating layer 150 or a portion of coating layer 150. Coat weight occasionally is used to refer to coating thickness, and can be interpreted to be the same or similar.

As used herein, coating thickness of coating layer 150 may be the thickness or depth at a particular location or an average across multiple locations along the exterior of the golf ball. For example, the thickness may be a relative length from the exterior of coating layer 150, where the coating is exposed to ambient air, to the underlying layer, which is typically cover layer 120. Coating layer 150 may often have a thickness ranging from 10 to 50 μm. However, coating layer 150 may have a thickness above or below these values, or may vary across surface of the golf ball. For example, coating layer 150 may have a thickness of 0.1, 5, 10, 20, 30, 40, 50, 75, or 100 μm.

Inconsistent thickness of coating layer 150 on a golf ball, whether too thick, too thin, or unevenly applied, can significantly alter its aerodynamic properties. For example, variations in thickness between the two halves of a golf ball may create imbalanced side-to-side forces, potentially causing substantial deviations from the intended flight path due to disrupted airflow and spin dynamics. Therefore, efficient measurement of coating thickness would be invaluable, particularly if done non-destructively such that any golf ball could be tested and still used for sport.

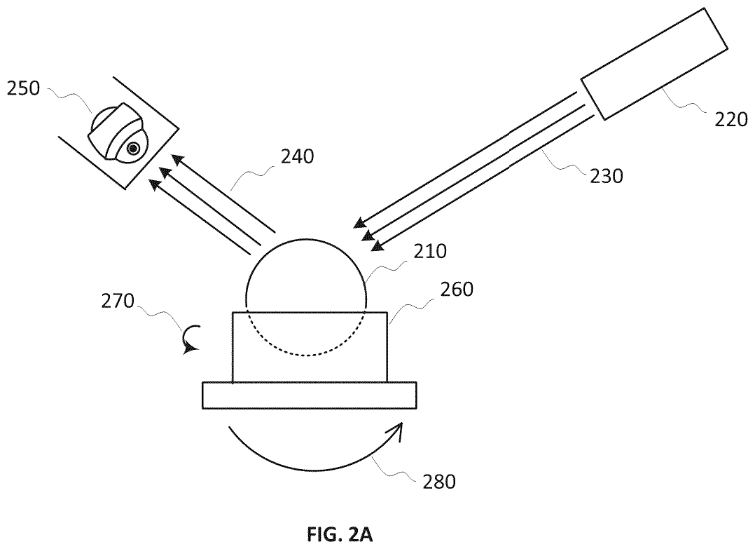

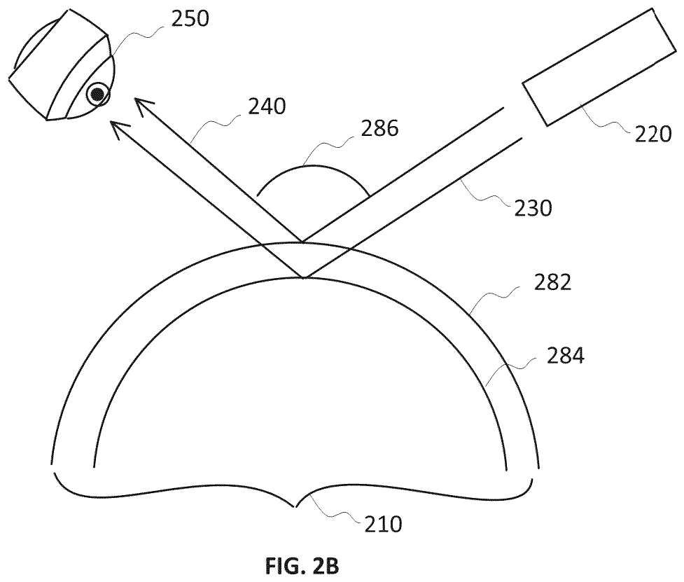

FIGS. 2A and 2B illustrate exemplary optical setup for optical detection of a coating layer for golf ball 210. FIG. 2A illustrates an example setup for detecting optical signals from golf ball 210. Optical signals may be the transmission of information or data using light as a medium of transmission. Light emitter 220 may produce or emit emitted light 230. Emitted light 230 may be incident on golf ball 210. After interacting with golf ball 210, emitted light 230 may be redirected as reflection 240 from golf ball 210 toward light sensor 250. As used herein, reflection 240 (or the term reflection in general) may refer to any light which reaches light sensor 250. Golf ball 210 may be mounted by mount 260. Mount 260 may be any structure that holds an object (e.g., golf ball 210) securely in place. Mount 260 may be any configured to maneuver in various directions or angles, including horizontal rotation 270 or vertical rotation 280. Rotation may occur about an axis of rotation. Mount 260 may comprise any of a range of degrees of freedom of translation or rotation of golf ball 210 to enable targeted incidence of light depending on where on golf ball 210 a measurement should be taken. FIG. 2B illustrates optical detection of properties of coating layer 282 (for golf ball 210). Coating layer 282 may have a coating thickness that may be measured as the length from the outer surface of coating layer 282 to the boundary with cover layer 284. In FIG. 2B, the size of coating layer 282 may be increased for visualization. Reflection angle 286 may be the angle between emitted light 230 and reflection 240. In some embodiments, a bisection of reflection angle 286 may be the normal of the surface of golf ball 210. In some other embodiments, the bisection may not be the normal.

Light may be any electromagnetic radiation of any wavelength. Emitted light 230 may include X-ray, ultraviolet, visible, or near or mid infrared wavelengths. X-ray wavelengths may range from about 0.01 to 10 nm. Ultraviolet wavelengths may range from about 10 to 400 nm. Visible wavelengths may range from about 380 to 780 nm. Near infrared wavelengths may range from about 750 to 2500 nm. Mid infrared wavelengths may range from about 2500 to 25000 nm. The particular selection of wavelength may be based on various factors relating to coating layer 282 or cover layer 284, a material contained in coating layer 282 or cover layer 284, or a physical characteristic related to the golf ball. For example, X-ray light tends to interact at the molecular level, so measurements of these interactions can giving information leading to precise measurements of thickness of the layers its passing through. The particular choice of wavelength may provide various advantages to measuring coating parameters. For example, visible light may provide a cost-effective means to assess coating thickness. Near infrared light may be safe and use minimal additive materials. X-ray light may provide high resolution measurements. The particular choice of wavelengths used may depend on the particular nature and composition of golf ball 210 and coating layer 282.

Emitted light 230 may include a single wavelength of light, a few discrete wavelengths, or a spectrum of light. Single wavelength emission may include sources such as lasers or laser diodes. Lasers may emit temporally and spatially coherent light, which may help to obtain measurements of thickness with greater accuracy. A single wavelength may be a discrete wavelength or very narrow wavelength range of emission. For example, a single wavelength may be emitted by a laser at 1064 nm with a tolerance range of +/−10 nm. A few discrete wavelengths may include multiple emissions from light emitters operating in parallel or from a light emitter configured to emit multiple discrete wavelengths of light. For example, an infrared light emitter and an ultraviolet light emitter may be used in parallel. For example, the alteration of the path or other characteristics of each of a set of discrete wavelengths may be compared before and after emitted light 230 interacts with golf ball 210. A spectrum of light may be a broad range of wavelengths. For example, a spectrum of light for emitted light 230 may allow for the a spectral analysis of the material properties of a layer of golf ball 210, or for a more precise measurement of coating thickness of coating layer 282 of golf ball 210 by tracking the varying paths of light for a range of wavelengths before and after interaction with golf ball 210.

Light from emitted light 230 which reaches golf ball 210, particularly coating layer 282, may be referred to as incident light. Depending on the particular material properties of coating layer 282 or cover layer 284, incident light may interact with the material or medium and be affected in different ways. Generally, incident light may be absorbed, reflected, or transmitted by the medium.

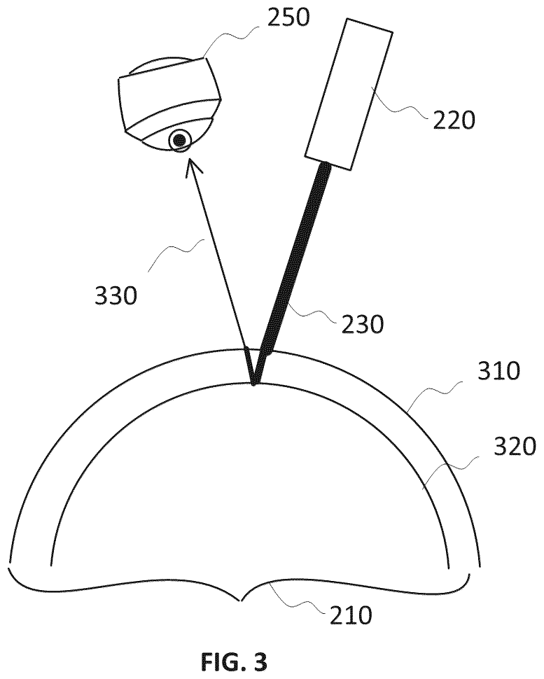

Absorbed light may be any light from emitted light 230 which is taken into a medium. During absorption, the energy from the incident light may decrease, as the energy is converted into electron excitation or heat energy. Wavelengths for emitted light 230 may be selected based on the absorption characteristics of a layer of golf ball 210. For example, a peak of absorption may occur for polyurethane at 1175 nm, so this may be one wavelength selected to assess how much absorption occurs, via a reduction in energy of the incident light, as measured by light sensor 250. The degree of absorption may be related to the path length of the incident light through the medium, which may be associated with the coating thickness. Further details on absorption are explored with regards to FIG. 3.

Reflected light may be any light from emitted light 230 that strikes a surface and bounces off through specular or diffuse reflection. During specular reflection, the reflection angle may be equal to the incident angle (i.e., producing reflection angle 286), with most of the light traveling along the same angle. Diffuse reflection may be caused by a rough surface and result in reflecting light in various directions. Typically with reflected light, most of the light energy is retained in the reflected light. Some small amount of energy may be lost in the medium on which the light reflected.

Transmitted light may be any light from emitted light 230 that is not absorbed or reflected. Transmitted light may continue traveling through a medium, such as coating layer 282 of golf ball 210, without changing direction, or, depending on material properties, transmitted light may travel in a modified direction.

Other optical phenomena that may occur when emitted light 230 reaches golf ball 210 may include polarization, dispersion, refraction, interference, fluorescence, scattering, diffraction, etc. Some of these optical phenomena may be used or accounted for when determining coating thickness or other coating properties of golf ball 210. In some embodiments, optical components related to any of these optical phenomena may be placed in the path of emitted light 230 or reflection 240. Calibration of optical signals (e.g., for light sensor 250) may be done using preestablished or known values to provide a baseline or relative value to which a signal may be normalized or adjusted. For example, various optical phantoms may be used to prepare for measurement of optical signals related to golf ball 210. For example, calibration or optical phantoms may assist in adjusting for the curvature of the surface of golf ball 210.

Polarization may be the process by which light waves are filtered or oriented so that their electric field vibrations occur in a specific direction, rather than in multiple planes as in unpolarized light. Polarization may be used to filter specular reflection (e.g., from coating layer 282) or detect anisotropies in the structure. For example, polarization may be used in ellipsometry to determine layer thickness by determining the relative change in phase and intensity as incident light traverses coating layer 282.

Dispersion may be separation of light as a function of its wavelengths as it passes through a medium, due to the variation of the refractive index with wavelength. Dispersion may be used to determine coating properties. For example, reflection angle 286 may increase as a function of wavelength from dispersion from coating layer 282.

Refraction may be the bending or changing of incident light as it passes into a medium, such as when entering coating layer 282. In some embodiments, the coating thickness of coating layer 282 may be determined by optical path length of the optical signal compared to emitted light 230, wherein coating layer 282 refracts the incident light. Refraction may be defined by the index of refraction for a medium, n=c/v, where c is the speed of light in a vacuum, and v is the speed of light in the medium. When entering a second medium from a first medium, the angle of refraction may be calculated by Snell's Law, n₁ sin θ₁=n₂ sin θ₂, where n₁ is the index of refraction in the first medium (typically air), n₂ is the index of refraction of the second medium (e.g., coating layer 282), θ₁ is the angle of incident light (e.g., angle of emitted light 230), and θ₂ is the angle of incident light after entering the second medium. Snell's Law also applies in reverse for reflected light (e.g., for reflection 240). For example, Snell's Law may be used to help calculate, at light sensor 250, the relative displacement position or angle of light after traveling through a layer of golf ball 210 relative to a specular reflection.

Interference of light from emitted light 230 may be a wave phenomenon that occurs when two or more waves overlap, resulting in a new wave pattern. Interference can be constructive, where the waves align in phase, amplifying the amplitude and increasing intensity, or destructive, where the waves are out of phase and cancel each other out, reducing intensity. For interference, the waves must be coherent and have the same or similar frequencies/wavelength. The path difference between the waves may produce a phase shift in the waves and cause the interference to be constructive or destructive. In some embodiments, light sensor 250 (described in further detail below) may use interferometry to detect the optical signal through a phase difference of the optical signal compared to emitted light 230. For example, interference may be measured with a Michelson interferometer by recombining the emitted and returning light using a beamsplitter. In some embodiments, interference may be used to measure a coating thickness of coating layer 282. For example, light emitter 220 may be a laser outputting emitted light 230 at a particular wavelength coherently, and some light may be reflected from the surface of coating layer 282, while some other light passes through coating layer 282, and upon reaching light sensor 250, the relative phase shift and time of flight (i.e., path length) may be compared to determine the coating thickness.

Fluorescence may be when incident light is temporarily absorbed by a medium and then release at another, usually longer, wavelength. The absorbed energy may excite atoms or molecules to a higher energy state, and when the energy state returns to a ground state, energy is release as light. Emitted light 230 may be incident on golf ball 210, and the incident light may cause fluorescence of coating layer 282 or cover layer 284. The fluorescent light may be included in reflection 240, and may be used to determine coating properties. For example, if coating layer 282 fluoresces, then there may be a relationship of the fluorescence intensity to the coating thickness. In another example, if cover layer 284 fluoresces, then the attention or redirection of fluorescence intensity may be related to the coating geometry. In yet another example, if cover layer 284 fluoresces in response to X-ray irradiation, and coating layer 282 attenuates X-rays, then a detection of the fluorescence intensity may directly inform the penetration depth of the X-rays, which would correspond to the coating thickness (e.g., through geometric calculation or correction).

Scattered light may be redirected with or without loss of energy. Scattering may occur where the incident light is neither fully reflected nor fully transmitted. Backscattered light may be emitted from a surface such as coating layer 282. Backscattered light may appear similar to reflected light. Scattering may be related to wavelength, so if the relative path length or other characteristics may be determined by knowing the general scattering phenomena that may occur in a medium, such as coating layer 282. For example, a phantom of similar composition and known geometries as coating layer 282 may be used to calibrate the optical signals relating to scattering of emitted light 230.

Diffraction may be similar to scattering in that light is redirected as a result of interaction with atoms or molecules. Diffraction of incident light (e.g., incident light from emitted light 230) may be the bending and spreading of incident light as it passes around an obstacle or through a narrow opening. Diffraction may result in a regular pattern of constructive and destructive interference. For example, diffraction may occur at the molecular level when X-rays traverse a crystalline structure and interact with the molecular groups or adjacent atoms. For example, X-ray light may have a wavelength on the order of the distance between atoms or molecules in the crystalline structure. For X-rays incident on a crystal structure at an angle θ, Bragg's Law may be used to determine the relationship between the X-rays and the crystal structure, by nλ=2d sin θ, where n is the integer order of diffraction (i.e., how many fringes from a central plane), λ is the wavelength, and d is the distance between adjacent crystal planes. When implemented in a particular configuration of X-ray source and detector with a detection slit placed at reflection angle 286 (e. g,. Bragg-Brentano geometry), a measurement of the diffraction angle from the sample, 2θ, may be determined (e.g., 2θ may be reflection angle 286 subtracted from 1). By rotating the sample (e.g., along horizontal rotation 270 or vertical rotation 280), peaks of the X-ray signals as a function of 2θ may be detected. These peaks provide information about the crystal structure of the medium (e.g., coating layer 282).

Diffraction may also be used to assess penetration depth of X-rays (e.g., in coating layer 282). The penetration depth may be obtained based on the linear absorption coefficient (μ) and the angle of incidence (θ) of the X-ray. For a penetration depth x, the diffraction intensity, Gₓ, may be described by Gₓ=1^{x}−e^{-2μx/sin θ}. The absorption coefficient may vary with X-ray wavelength and can be found in reference tables or reference books. Using such a formula and configuration of light emitter 220 and light sensor 250 relative to golf ball 210, coating properties, including coating thickness, may be determined.

In some embodiments, the incident light may include an X-ray wavelength and X-ray diffraction may be used to determine the coating thickness. For example, penetration depth may be assessed based on the diffraction intensity. Consistent with some embodiments, cover layer 284 may include a crystalline additive to enhance the determination of the coating thickness. For example, incorporating crystalline additives into the coating may enhance the measurement of diffraction peaks (i.e., 2θ) and the detection of X-rays at reflection angle 286. For example, the improved detection of X-rays may enhance the accuracy of the calculation of penetration depth, and therefore improve the accuracy of determining coating thickness.

In some embodiments, an emitted wavelength of emitted light 230 may be matched to a predetermined coating thickness. For example, a predetermined coating thickness may be based on aerodynamic performance of golf ball 210. If a predetermined coating thickness is known, the selection of the emitted wavelength may be based on whether optical phenomena such as interference, refraction, or absorption are being used. For example, with interferometry, the predetermined coating thickness may be an integer multiple of the emitted wavelength, so any deviations in thickness would result in a phase shift and difference in interference.

In one explanation, the total light energy of incident light from emitted light 230 or incident light may be thought of as a sum of the absorbed, reflected, and transmitted light through one or more layers of golf ball 210. Other optical phenomena (such as those described previously) may be used to refine the calculation relating to changes in energy. For example, the change in light energy from incident light to reflection 240 may be different at different wavelengths. For example, at one wavelength, more absorption may occur than at another wavelength, and this may be measured. In another example, one wavelength may reflect more light than at another wavelength. Changes in the energy from incident light from light emitter 220 to reflection 240 received by light sensor 250 may be detected and used to determine properties such as coating thickness of coating layer 282.

Reflection 240 may include reflected light, fluoresced light, scattered light, diffracted light, etc. Light sensor 250 may be a device that detects or measures light intensity by converting light energy into an electrical signal. As light is electromagnetic radiation, it possesses a wave-particle duality. Light sensor 250 may include a photodiode, phototransistor, photoresistor, charge-coupled device (CCD), complementary metal-oxide semiconductor (CMOS), or other detector or camera. In some embodiments, light sensor 250 may be a single detector element such as a pixel. In some other embodiments, light sensor 250 may be a detector with multiple pixels or elements, such as a camera. The choice of light sensor 250 for determining coating properties of golf ball 210, such as coating thickness, depends on the particular characteristics of emitted light 230 such as wavelength, or the material properties of golf ball 210.

Emitted light 230 may be continuous or pulsed, or a combination thereof. Continuous light may be light that is release as a constant, unbroken stream. For example, if emitted light 230 is continuous, the intensity of emitted light 230 may be constant over time. Continuous light may be emitted by incandescent bulbs, light-emitting diodes (LEDs), arc lamps, or lasers. Pulsed light may be light emitted in discrete bursts in an on-off or high-low pattern. For example, emitted light 230 may be modulated using an external transistor-transistor-logic (TTL) pulse train. Pulsed light may be done with any light source, including lasers. Pulses may be modulated to produce pulses with pulse widths that typically vary from femtoseconds to milliseconds.

In some embodiments, the incident light of emitted light 230 may include a near infrared wavelength. This may be a single wavelength, or a range of wavelengths. Consistent with some embodiments, coating layer 282 may be optically transparent to the near infrared light and cover layer 284 may be optically reflective of the near infrared light. Optically transparent may be a high transmission of light such that little absorption, reflection (or scattering) occurs. For example, cover layer 284 may include a material that is highly reflective of the near infrared light. Measurement of coating thickness or other properties may be done by measuring this reflected light, and perhaps comparing it to another signal, such as specularly reflected light from surface of coating layer 282. Consistent with some embodiments, coating layer 282 may absorb a portion of the near infrared light and a remaining portion of the near infrared light may include the reflection. If absorption of near infrared light occurs in coating layer 282, then, as discussed previously, the optical signal may be attenuated and the degree of attenuation may help determine coating thickness or other properties. The coating thickness may be determined quantitatively or quantitatively. For example, coating thickness may be shown in a color temperature scale, rather than a numerical one.

In some embodiments, the incident light of emitted light 230 may include a visible wavelength. This may be a single wavelength, or a range of wavelengths. Consistent with some embodiments, coating layer 282 may be optically transparent to the visible light and cover layer 284 may be optically reflective of the visible light. For example, differences in pigmentation may enable a difference in reflection of different wavelengths for coating layer 282 or cover layer 284. These differences may enable a determination of coating thickness or other properties. Consistent with some embodiments, cover layer 284 may include a reflective additive to increase the reflection of the incident light. The reflective additive may be a coating or an integration into the material composition of cover layer 284. The coating thickness may be determined quantitatively or quantitatively. For example, coating thickness may be shown in a color temperature scale, rather than a numerical one.

A computer system or processor may be used for determining a coating thickness of coating layer 282 from the optical signal. The processor may be configured to engage directly with light sensor 250. The processor may include various types of processing devices. For example, the processor may include a microprocessor, preprocessors (such as an image preprocessor), a graphics processing unit (GPU), a central processing unit (CPU), support circuits, digital signal processors, integrated circuits, processor memory, or any other types of devices suitable for running applications and for image processing and analysis. In some embodiments, the processor may include any type of single or multi-core processor, mobile device microcontroller, central processing unit, etc. In some embodiments, the processor may constitute a single core or multiple core processor that executes parallel processes simultaneously. For example, the processor may use logical processors to simultaneously execute and control multiple processes. The processor may implement virtual machine technologies or other known technologies to provide the ability to execute, control, run, manipulate, store, etc. multiple software processes, applications, programs, etc. Various processing devices may be used, including, for example, processors available from manufacturers such as Intel®, AMD®, etc., or GPUs available from manufacturers such as NVIDIA®, ATI®, etc. and may include various architectures. One of ordinary skill in the art would understand that other types of processor arrangements could be implemented that provide for the capabilities disclosed herein.

In some embodiments, light sensor 250 and the processor may use spectroscopy to determine the coating thickness. Spectroscopy may be an investigation of spectra produced when matter interacts with light. Spectroscopy may be used to measure coating thickness by analyzing how light interacts with the coated surface. For example, spectroscopy may include reflection/transmission spectroscopy, ellipsometry, Raman spectroscopy, and X-ray fluorescence (XRF) that may detect changes in the light's intensity, polarization, or scattering properties, which may be influenced by the coating thickness and material properties of coating layer 282. XRF may be used to assess coating thickness based on the absorption and emission of X-rays through fluorescence. Raman spectroscopy and Fourier transform infrared spectroscopy (FTIR) may be used to determine coating thickness.

In some embodiments, golf ball 210 may be rotated using mount 260 to enable a scanning of coating layer 282. Mount 260 may include a device that allows golf ball 210 to be rotated in any axis (e.g., horizontal rotation 270 or vertical rotation 280) to expose the surfaces of coating layer 282 to incident light. The rotation may ensure that coating layer 282 is scanned across the entire surface, providing a full, 360-degree analysis of coating layer 282. In some embodiments, scanning may be targeted to specific regions, including dimples on golf ball 210. For example, a processor may be used to store data related to properties or quality of coating layer 282 (e.g., coating thickness), optical signals, or other data.

In some embodiments, a first coating thickness at a first location on coating layer 282 may be compared to a second coating thickness at a second location on coating layer 282. For example, incident light may be directed to one location and a measurement of the optical signal and determination of the first coating thickness may be performed, and then mount 260 may be rotated to a new position, and a new measurement may be taken. In some embodiments, if the first coating thickness is inconsistent with the second coating thickness, golf ball 210 may be rejected during manufacturing. For example, this process may be a quality control during in-line testing of golf ball 210. There may be a rejection threshold during manufacturing whereby if the difference in thicknesses is above the rejection threshold, then golf ball 210 is rejected. In some embodiments, the second location may be a dimple on golf ball 210. For example, the thickness at a non-dimple (e.g., fret or laminar flow region) location on the surface of golf ball 210 may be compared to the thickness at a dimple location.

In some embodiments, a map of the coating quality on the coating layer may be generated using the scanning. Such a map may be stored for further use or reference, or may be displayed to a user, such as a person manufacturing golf ball 210. For example, the map may be displayed on a monitor or a graphical user interface.

FIG. 3 illustrates an example of optical detection of properties of absorbing coating layer 310. FIG. 3 may incorporate by reference from FIGS. 2A-2B, golf ball 210, light emitter 220, emitted light 230, and light sensor 250. The relative size of absorbing coating layer 310 may be enlarged in FIG. 3 for visualization. Depicted by a thinning black line in FIG. 3, attenuation of incident light from emitted light 230 may occur after entering absorbing coating layer 310 and refracting based on the angle of incidence. Upon reflection off of reflecting cover layer 320, the light may be further attenuated until it escapes coating layer 310 with another refraction event, allowing attenuated reflection 330 to travel toward light sensor 250 for detection.

Absorbing coating layer 310 may be similar to coating layer 282 from FIG. 2B, and absorbing coating layer 310 may include materials which absorbed at the wavelengths of emitted light 210. For example, emitted light 210 may be visible or near infrared light which is attenuated when passing through absorbing coating layer 310. For example, the level of attenuation may be determined by the Beer-Lambert Law, A=εcl, where A is the absorbance, ε is the molar absorptivity, c is the concentration of the absorber, and l is the path length (i.e., the total length traversing coating layer 310). The molar absorptivity may be a constant that can be found in reference tables. The concentration may be known from previous testing or known material properties. More complex calculations of Beer-Lambert Law may also take into account scattering effects in the medium. By measuring absorbance, such as the relative attenuation of the incident light, the total path length may be determined. Further calculations including refraction angle, lateral displacement or shift of the light, or use of other wavelengths, may aid in determining the coating thickness or other properties of absorbing coating layer 310.

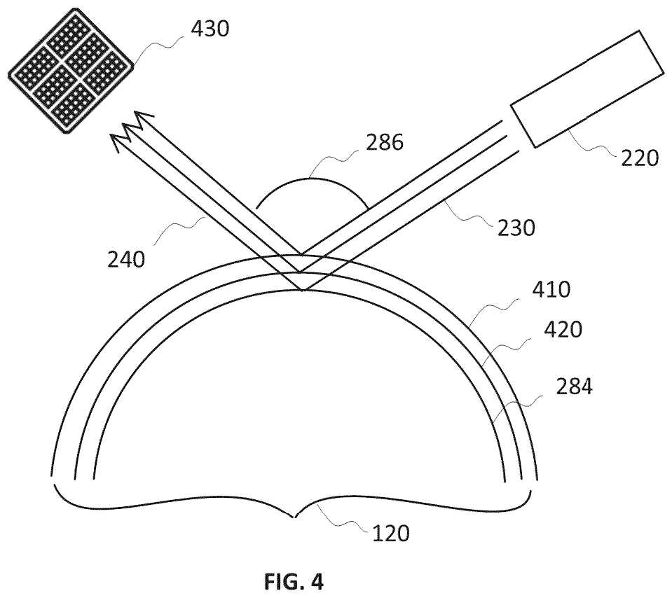

FIG. 4 illustrates optical detection of multiple layers on a golf ball (e.g., golf ball 120). FIG. 4 incorporates by reference from FIGS. 2A-2B, light emitter 220, emitted light 230, reflection 240, cover layer 284, and reflection angle 286. Golf ball 120 may include first coating layer 410, and second coating layer 420, in addition to cover layer 284. Incident light may enter first coating layer 420, and some of the incident light may continue passing through first coating layer 410 to second coating layer 420. Some of the incident light may be reflected by a boundary of first coating layer 410 and second coating layer 420, and some of the incident light may be reflected by a boundary of second coating layer 420 and cover layer 284. Reflection 240 may include both sets of these reflected light. Reflection 240 may be directed toward detector array 430. Detector array 430 may be similar to light sensor 250 from FIGS. 2A-3, and detector array 430 may include a plurality of light sensors or a two-dimensional array of detectors or pixels configured to receive the various positions of light in reflection 240. From these various positions of light distributed on detector array 430, the properties of the coating layers may be determined.

In some embodiments, golf ball 210 may include first coating layer 410 and second coating layer 420 different from first coating layer 410, wherein a processor is configured to determine a first coating thickness associated with first coating layer 410 and a second coating thickness associated with second coating layer 420. For example, different wavelengths may be used based on the material properties of first coating layer 410 and second coating layer 420, and the position of the wavelengths on detector array 430 may enable a determination of the thickness of the coating layers.

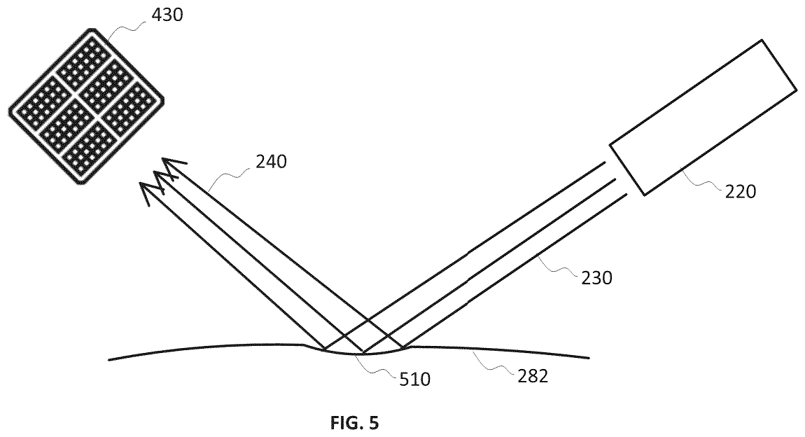

FIG. 5 illustrates optical detection of dimple 510 (e.g., of golf ball 210 in FIGS. 2A-4). FIG. 5 incorporates by reference from FIGS. 2A-2B and 4, light emitter 220, emitted light 230, reflection 240, coating layer 282, and detector array 430. In some embodiments, a surface of a golf ball may include dimple 510 overlaid with a coating layer 282. Dimple 510 may complicate the calculation of a coating thickness or other properties of a golf ball, particularly because a golf ball's outer surface possesses curvature. The perimeter of dimple 510 may present inflection points where curvature suddenly changes from convex to concave. This change presents a drastic change in optical effects. For example, at the outer boundary of coating layer 282 or the inner boundary (i.e., the boundary with cover layer 284 of FIGS. 2A-2B), the concave geometry of dimple 510 may serve to redirect light in reflection 240 together. In some embodiments, processor and detector array 430 may be configured to account for this redirection of light in reflection 240 and determine a coating thickness of coating layer 282. For example, multiple wavelengths sent from multiple positions or angles from light emitter 220 may reach multiple positions on dimple 510 or the surrounding surface of the golf ball, and the relative distance between detection events on the pixels of detector array 430 may be used to calculate the path length or other variables.

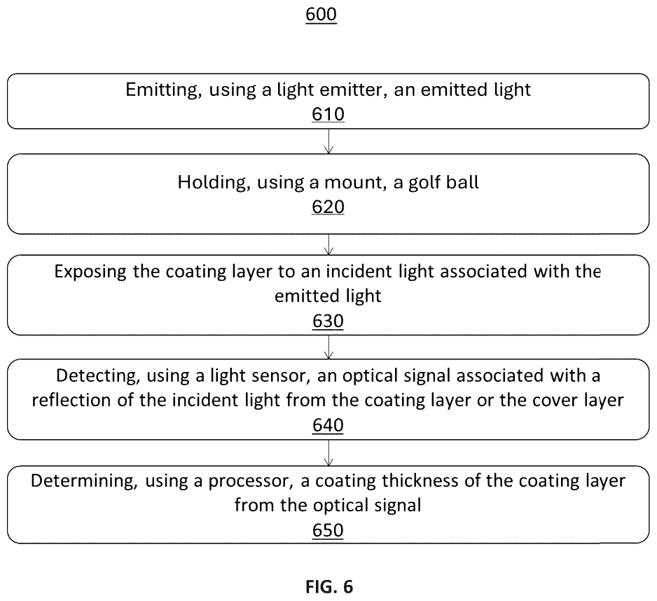

FIG. 6 is a flowchart illustrating an example process 600 for determining a coating thickness of a golf ball. Process 600 is discussed herein for explanatory purposes and is not intended to be limiting. In some embodiments, steps of process 600 may be changed, modified, substituted, or rearranged, consistent with the present disclosure. Process 600 may use any of the embodiments or systems described in FIGS. 1-5 or the corresponding description. In step 610, process 600 may include emitting, using a light emitter, an emitted light. For example, the emitted light may include visible, near infrared, or X-ray light.

In step 620, process 600 may include holding, using a mount (e.g., mount 260 in FIG. 2A), a golf ball. The golf ball may include a cover layer (e.g., cover layer 284 from FIG. 2B) and a coating layer (e.g., coating layer 282 from FIG. 2B) or absorbing on the cover layer. The golf ball may include any number of coating layers. The coating layer may be a thin paint or polyurethane coating over the cover layer. For example, the coating layer may include a primer layer and a top coat layer.

In step 630, process 600 may include exposing the coating layer to an incident light associated with the emitted light. Incident light may be all or a portion of emitted light from a light emitter. The incident light may include a single wavelength (or narrowband of wavelengths), or a spectrum or range of wavelengths, depending on the material properties of coating layer or cover layer and which coating property is to be determined.

In step 640, process 600 may include detecting, using a light sensor, an optical signal associated with a reflection of the incident light from the coating layer or the cover layer. The reflection may include light which was reflected, scattered, diffracted, refracted, absorbed, or other modified by the coating layer of a golf ball or a cover layer, as described with regards to FIGS. 2A-5. For example, emitted light may be X-rays and X-ray diffraction may be used. Any number of additional optical elements may be positioned in the pathway of emitted light or the reflection. For example, optical elements may include lens, beamsplitters, polarizers, mirrors, prisms, diffraction gratings, slits, holes, filters, waveplates, optical fibers, modulators, or coatings. Each of these elements may be selected to modify the path, intensity, or other characteristic of light before reaching the light sensor (e.g., light sensor 250 of FIGS. 2A-3 or detector array 430 of FIGS. 4-5).

In step 650, process 600 may include determining, using a processor, a coating thickness of the coating layer from the optical signal. By knowing the type of optical phenomena related to the optical signal, the geometry of the optical setup, the material properties of the coating layer and cover layer, it is possible to determine the coating thickness from the optical signal. For example, if X-ray diffraction is used, the penetration depth may be calculated using known equations and the detected X-ray reflection in the optical signal via light sensor of FIGS. 2A-3 or detector array of FIGS. 4-5.

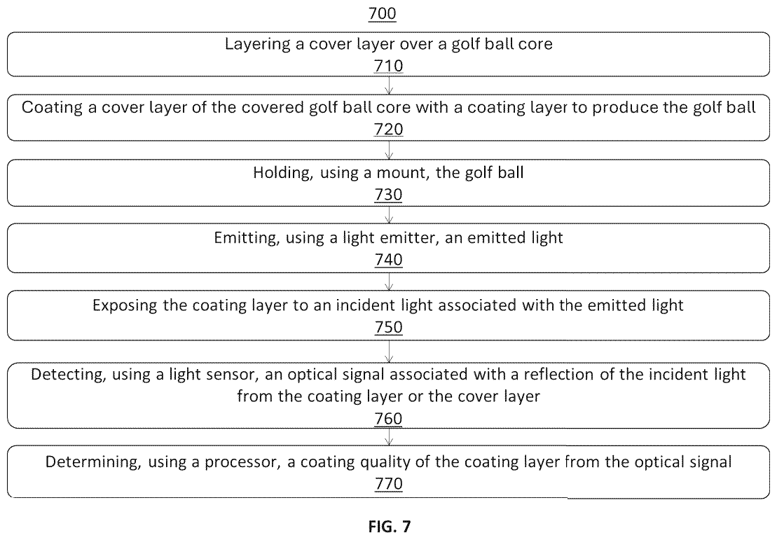

FIG. 7 is a flowchart illustrating an example process 700 for determining a coating thickness of a golf ball during manufacturing. Process 600 is discussed herein for explanatory purposes and is not intended to be limiting. In some embodiments, steps of process 1000 may be changed, modified, substituted, or rearranged, consistent with the present disclosure. Process 700 may use any of the embodiments or system described in FIGS. 1-5 or the corresponding description. Process 700 may also incorporate process 600.

In step 710, process 700 may include layering a cover layer (e.g., cover layer 284 of FIG. 2B) over a golf ball core (e.g., core layer 110 of FIG. 1). Any number of layers may be used depending on the desired aerodynamic, or elastic properties of the golf ball.

In step 720, process 700 may include coating a cover layer of the covered golf ball core with a coating layer to produce the golf ball. The coating layer may be any number of layers and may include a water-based coating, a paint, a polyurethane coating, etc. For example, the coating layer may include a primer layer and a top coat layer.

In step 730, process 700 may include holding, using a mount, the golf ball. The mount (e.g., mount 260 in FIG. 2A) may rotate in any direction to position the golf ball in the path of incident light at a precise location. For example, the mount may include rollers, rotating elements, various grips or clamps, etc.

In step 740, process 700 may include emitting, using a light emitter, an emitted light. Emitted light may include a single wavelength (or narrowband of wavelengths), or a spectrum or range of wavelengths, depending on the material properties of coating layer or cover layer and which coating property is to be determined. For example, a light emitter may include a LED, laser, laser diode, etc.

In step 750, process 700 may include exposing the coating layer to an incident light associated with the emitted light. Incident light may be all or a portion of emitted light from a light emitter. The incident light may include a single wavelength (or narrowband of wavelengths), or a spectrum or range of wavelengths, depending on the material properties of coating layer or cover layer and which coating property is to be determined.

In step 760, process 700 may include detecting, using a light sensor, an optical signal associated with a reflection of the incident light from the coating layer or the cover layer. The reflection may include light which was reflected, scattered, diffracted, refracted, absorbed, or other modified by the coating layer of a golf ball or a cover layer, as described with regards to FIGS. 2A-5. For example, emitted light may be X-rays and X-ray diffraction may be used. Any number of additional optical elements may be positioned in the pathway of emitted light or the reflection. For example, optical elements may include lens, beamsplitters, polarizers, mirrors, prisms, diffraction gratings, slits, holes, filters, waveplates, optical fibers, modulators, or coatings. Each of these elements may be selected to modify the path, intensity, or other characteristic of light before reaching the light sensor (e.g., light sensor 250 of FIGS. 2A-3 or detector array 430 of FIGS. 4-5).

In step 770, process 700 may include determining, using a processor, a coating quality of the coating layer from the optical signal. Coating quality may be the consistency, uniformity, thickness, or other properties of the coating layer. By knowing the type of optical phenomena related to the optical signal, the geometry of the optical setup, the material properties of the coating layer and cover layer, it is possible to determine the coating thickness from the optical signal. For example, if X-ray diffraction is used, the penetration depth may be calculated using known equations and the detected X-ray reflection in the optical signal via light sensor of FIGS. 2A-3 or detector array of FIGS. 4-5. This determination may be done in real-time, allowing for in-line inspection of coating quality during manufacturing in a non-destructive manner. Similarly, coating quality may be determined in field testing using portable devices which operate according to some embodiments disclosed herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. An apparatus for optically determining coating properties of a golf ball comprising a cover layer and a coating layer on the cover layer, the apparatus comprising:
a light emitter for emitting an emitted light;
a mount for holding the golf ball, wherein, when the golf ball is held by the mount, the coating layer is exposed to an incident light associated with the emitted light;
a light sensor for detecting an optical signal associated with a reflection of the incident light from the coating layer or the cover layer; and
a processor for determining a coating thickness of the coating layer from the optical signal.

2. The apparatus of claim 1, wherein the incident light comprises a near infrared wavelength.

3. The apparatus of claim 2, wherein the coating layer is optically transparent to the near infrared light and the cover layer is optically reflective of the near infrared light.

4. The apparatus of claim 2, wherein the coating layer absorbs a portion of the near infrared light and a remaining portion of the near infrared light comprises the reflection.

5. The apparatus of claim 1, wherein the incident light comprises a visible wavelength.

6. The apparatus of claim 5, wherein the coating layer is optically transparent to the visible light and the cover layer is optically reflective of the visible light.

7. The apparatus of claim 5, wherein the cover layer comprises a reflective additive to increase the reflection of the incident light.

8. The apparatus of claim 1, wherein the incident light comprises an X-ray wavelength and X-ray diffraction is used to determine the coating thickness.

9. The apparatus of claim 8, wherein the cover layer comprises a crystalline additive to enhance the determination of the coating thickness.

10. The apparatus of claim 1, wherein the emitted light is pulsed light.

11. The apparatus of claim 1, wherein the processor is further configured to determine the coating thickness by optical path length of the optical signal compared to the emitted light, wherein the coating layer refracts the incident light.

12. The apparatus of claim 1, wherein the light sensor uses interferometry to detect the optical signal through a phase difference of the optical signal compared to the emitted light.

13. The apparatus of claim 1, wherein an emitted wavelength of the emitted light is matched to a predetermined coating thickness.

14. The apparatus of claim 1, wherein the light sensor and the processor use spectroscopy to determine the coating thickness.

15. The apparatus of claim 1, wherein the golf ball comprises a first coating layer and a second coating layer different from the first coating layer, wherein the processor is further configured to determine a first coating thickness associated with the first coating layer and a second coating thickness associated with the second coating layer.

16. The apparatus of claim 1, wherein a surface of the golf ball comprises a dimple and the coating layer covers the dimple.

17. A method for optically determining coating properties of a golf ball comprising a cover layer and a coating layer on the cover layer, the method comprising:
emitting, using a light emitter, an emitted light;
holding, using a mount, the golf ball;
exposing the coating layer to an incident light associated with the emitted light;
detecting, using a light sensor, an optical signal associated with a reflection of the incident light from the coating layer or the cover layer; and
determining, using a processor, a coating thickness of the coating layer from the optical signal.

18. A system for optically determining coating properties of a golf ball comprising a cover layer and a coating layer on the cover layer, the system comprising:
a light emitter for emitting an emitted light;
a mount for holding the golf ball, wherein the coating layer is exposed to an incident light associated with the emitted light;
a light sensor for detecting an optical signal associated with a reflection of the incident light from the coating layer or the cover layer; and
a processor for determining a coating thickness of the coating layer from the optical signal.

19. A manufacturing method for a golf ball, the manufacturing method comprising:
layering a cover layer over a golf ball core;
coating a cover layer of the covered golf ball core with a coating layer to produce the golf ball;
holding, using a mount, the golf ball;
emitting, using a light emitter, an emitted light;
exposing the coating layer to an incident light associated with the emitted light;
detecting, using a light sensor, an optical signal associated with a reflection of the incident light from the coating layer or the cover layer; and
determining, using a processor, a coating quality of the coating layer from the optical signal.

20. The manufacturing method of claim 19, further comprising comparing a first coating thickness at a first location on the coating layer to a second coating thickness at a second location on the coating layer.

21. The manufacturing method of claim 20, further comprising rejecting, if the first coating thickness is inconsistent with the second coating thickness, the golf ball.

22. The manufacturing method of claim 20, wherein the second location is a dimple on the golf ball.

23. The manufacturing method of claim 19, further comprising rotating the golf ball using the mount to enable a scanning of the coating layer.

24. The manufacturing method of claim 23, wherein a map of the coating quality on the coating layer is generated using the scanning.
